(19) United States
(12) Patent Application Publication
(10) Pub. No.: US 2025/0009587 A1
(43) Pub. Date: Jan. 9, 2025

(54) EXOSKELETON

(71) Applicant: VRIJE UNIVERSITEIT BRUSSEL, Brussel (BE)

(72) Inventors: Matthias NAF, Ennetbaden (CH); Carlos GUERRERO RODRIGUEZ, Elsene (BE); Dirk LEFEBER, Sint-Agatha-Rode (BE); Joost GEEROMS, Liedekerke (BE); Vincent DUCASTEL, Brussel (BE)

(21) Appl. No.: 18/706,849

(22) PCT Filed: Nov. 8, 2022
(86) PCT No.: PCT/EP2022/081179

§ 371 Date: May 2, 2024

(30) Foreign Application Priority Data
Nov. 8, 2021 (EP) 21206969.4

(51) Int. Cl. A61H 1/02; A61H 3/00

(52) U.S. Cl. CPC A61H 1/0292; A61H 3/00; A61H 2201/0103; A61H 2201/164

(57) ABSTRACT

A supporting exoskeleton having a rigid main body, and a hip engagement member for engagement of the rigid main body with a hip of a person when wearing the supporting exoskeleton. The exoskeleton includes first and second lower members rotatably attached to the main body such that an axis of the rotation of the first lower member substantially coincides with an axis of a rotation of a left and right hip joints of the person. The exoskeleton also comprises a differential coupler, adapted for, in an engagement mode of the differential coupler, differentially coupling the rotation of the first lower member to the rotation of the second lower member.

### TECHNICAL FIELD OF THE INVENTION

The present invention relates to the field of supporting exoskeletons.

### BACKGROUND OF THE INVENTION

Worldwide, low back pain is a tremendous problem, affecting a large percentage of the population, and is, in terms of years lived with disability, the most prevalent condition according to the Global Burden of Disease Study (2017). While changes to the workplace to improve the ergonomics and the installation of cranes etc. can alleviate the problem, in some workplaces these changes are not possible, e.g. people who install washing machines and farm workers.

For these cases, body worn solutions in the form of exoskeletons have been proposed, giving the wearer the ability to move around, but still provide support, as needed. However, there are challenges associated especially with supporting the lower back. While it is desirable to give the wearer a large range of motion, so that his/her work is not hindered, at extreme forward bending angles, for many people the muscles turn off and the trunk is supported by passive structures (tendons and ligaments). This phenomenon is known in the literature as flexion-relaxation, and poses an extraordinary risk for low back injury, because the forces acting on the spine are very large and at the same time the perceived muscle exertion is small (the subject does not get tired quickly as there is no muscle activation) and therefore might stay in this condition for a long duration. One way to address this problem is to individually limit the maximum range of motion of the spine, with a mechanism that stays close to the body (important in a work environment) but still allows for very large and natural movements (there is a large range where movement is possible, without causing harm or injuries). However, this range varies from person to person, so that individual adjustability is desirable.

Since this is a relatively new field, the above-mentioned problem has not fully been solved in the art, although partial solutions have been found. Although not designed for this purpose, a common used approach is to use a rigid structure at the back, such as a rigid rod located along the spine of the wearer, and introduce some slack with the connection to the body. This solution by itself provides an end stop of how far the trunk can move, but the range of motion is typically very limited and does not follow the anatomy of the wearer closely. In order to increase the range of motion of the trunk, flexible beams have been used instead. While these beams allow for vastly improved movement and stays close to the body following the natural curvature of the spine, no individual limit on the flexion is provided.

In addition to this problem of finding a balance between flexibility on one hand and maximum flexion on the other hand, existing exoskeletons provide support while being “engaged” and allow to walk when being “disengaged”. Switching between the two states is not easy and usually requires a manual intervention, which is not possible when the hands are involved in another action such as carrying a load. Automatic solutions require high-functioning control algorithms, which require more complexity (electronics, motors, etc.). Furthermore, most existing exoskeletons provide support in symmetric poses and with legs side by side, but don't consider asymmetric lifting poses with one leg forward and one to the back. This means the user needs to fight against the device for some of the most frequent lifting postures. In addition, existing exoskeletons include actuation means at hip level which interferes significantly with the natural range of motion of the arms. Finally, existing exoskeletons have usually rigid links and structures, which compromise the natural trunk flexion range of motion.

A supporting exoskeleton that partially addresses the problem of finding a compromise between flexibility and maximum flexion has been proposed by YANG, Xiaolong, et al. Spine-inspired continuum soft exoskeleton for stoop lifting assistance. IEEE Robotics and Automation Letters, 2019, 4.4:4547-4554. Their robot is conformal to human anatomy and can reduce multiple types of forces along the human spine such as the spinae muscle force, shear, and compression force of the lumbar vertebrae.

There is still a need in the art for devices and methods that address at least some of the above problems.

### SUMMARY OF THE INVENTION

It is an object of the present invention to provide a good supporting exoskeleton. It is a further object of the present invention to provide a good method for making the supporting exoskeleton.

The above objective is accomplished by a method and apparatus according to the present invention.

It is an advantage of embodiments of the present invention that local overstretching of the spine of a person wearing the supporting exoskeleton may be prevented. It is a further advantage of embodiments of the present invention that the supporting exoskeleton may enable a targeted and personalized maximum flexion of the supporting exoskeleton. For example, bending of the supporting exoskeleton at the lower back (that is most sensitive to injuries) may be limited, thereby limiting bending of the lower back spine of the person so as to prevent injuries to the lower back.

It is an advantage of embodiments of the present invention that the intermittent support enables stiffening of the bending of the vertical elastic element (that is, in combination with the intermittent support). Hence, due to the presence of the intermittent support, the supporting exoskeleton may provide more support.

In a first aspect, the present invention relates to a supporting exoskeleton. The supporting exoskeleton comprises a vertical elastic element, and an intermittent support. The intermittent support comprises a plurality of exoskeleton vertebra elements positioned along at least a portion, e.g., at least 20%, preferably as at least 50%, more preferably at least 80% by length, of the vertical elastic element. The number of exoskeleton vertebra elements may be at least 2, e.g. at least 3, e.g. 4 or more exoskeleton vertebra elements. At least said portion of the vertical elastic element is adapted to be positioned along a back spine of a person when wearing the supporting exoskeleton. Preferably, the vertical elastic element is adapted to be positioned along a back spine of said person when wearing the supporting exoskeleton. Preferably, said portion is at least along a lower back spine of said person when wearing the supporting exoskeleton. At least one of the exoskeleton vertebra elements, e.g. at least two of the exoskeleton vertebra elements or e.g. all of the exoskeleton vertebra elements, is/are coupled to the vertical elastic element. Alternatively, the intermittent support may be integrated with the vertical elastic element, so that the plurality of exoskeleton vertebra elements are coupled to each other by the vertical elastic element. Adjacent exoskeleton vertebra elements are tiltably connected with each other, wherein the tilting is in a tilt plane. Preferably, each pair of adjacent exoskeleton vertebra elements is configured for stopping, e.g., limiting said tilting in the tilt plane at a predetermined maximum tilt angle, wherein the intermittent support comprises means for changing said predetermined maximum tilt angle. It is an advantage of embodiments of the present invention that said means may provide easy adaptation of the predetermined maximum tilt angle, thereby providing personalization of the supporting exoskeleton or adaptation to the circumstances required for the person when wearing the supporting exoskeleton. In preferred embodiments, bending, in the tilt plane, of the vertical elastic element along the pair of adjacent exoskeleton vertebra elements is limited to a bend radius of at least 50 cm, such as 100 cm, preferably at least 200 cm. When the bend radius is larger, there may be less risk for back injuries. When the bend radius is smaller, there may be more freedom to move for the person.

The elastic element may be bending while the rigid vertebra elements are bending with respect to each other. The bend radius of the elastic element may be locally defined along the elastic element.

In embodiments, the supporting exoskeleton further comprises a hip engagement member. The vertical elastic element may be coupled to the hip engagement member for engagement with a hip of a person. In embodiments, the supporting exoskeleton further comprises an upper torso engagement member The vertical elastic element may be coupled to the upper torso engagement member for engagement with an upper part of a torso of said person.

When said tilting stops, tilting any further would require exerting a large torque. In embodiments, said tilting is assumed to be stopped if a derivative of a torque exerted on the adjacent exoskeleton vertebra elements to tilt the adjacent exoskeleton vertebra elements further, preferably in absence of the vertical elastic element, is at least 1 Nm/degree, preferably at least 5 Nm/degree, more preferably at least 10 Nm/degree. In embodiments, said tilting may be assumed to be stopped if further tilting, i.e., tilting beyond the predetermined maximum tilt angle, would require substantially more torque compared to the torque required for tilting the adjacent exoskeleton vertebra elements from a situation wherein the adjacent exoskeleton vertebra elements, and possibly the portion of the vertical elastic element along the adjacent exoskeleton vertebra elements, are straight (i.e., the adjacent exoskeleton vertebra elements are at a tilt angle of 0°), to a situation wherein the adjacent exoskeleton vertebra elements are tilted by the predetermined maximum tilt angle. In embodiments, tilting is assumed to be stopped when a torque exerted on the exoskeleton vertebra elements, preferably in absence of the vertical elastic element, as dependent on tilt angle at a particular tilt angle, i.e., the predetermined maximum tilt angle, (in other words: the derivative of the torque with respect to the particular tilt angle, which expresses the work performed by the device) is at least five times, preferably at least ten times, e.g., exactly five times, preferably at least ten times, larger than the torque divided by the particular tilt angle, i.e., the predetermined maximum tilt angle.

In some embodiments, the tilting is assumed to be stopped when the derivative of the torque with respect to the tilt angle is at least five times larger than the torque divided by the tilt angle. The tilting may be assumed to be stopped where the stiffness is e.g. 5 times higher than in the ‘free zone’. This can in some embodiments be when two vertebra hit each other (and cannot tilt further) or for example in embodiments using a cable, when the cable is stopping them from tilting further. Bending of the vertical elastic element is typically nonlinear, and the vertical elastic element, in absence of the intermittent support, may also have a limited bend radius, limited by the large amount of torque required to bend the vertical elastic element any further. The limited bend radius of the vertical elastic element may, however, be so large that the person may be injured at the back. Furthermore, when bending is limited by the vertical elastic element, a lot of torque is exerted on the vertical elastic element, and structural integrity of the vertical elastic element may be lost. It is an advantage of the intermittent support that the bend radius may become more limited. It is a further advantage of the intermittent support helps maintaining the vertical elastic element's structural integrity may be retained. It is an advantage of embodiments of the present invention that the supporting exoskeleton may be flexible while upright, i.e., straight, but becomes rigid by flexing. In embodiments, the predetermined maximum tilt angle is determined based on a yield stress of the vertical elastic element. In embodiments, the predetermined maximum tilt angle is configured for limiting stress in the vertical elastic element along the pair of adjacent exoskeleton vertebra elements to less than 90%, preferably less than 70%, such as less than 50% of the yield stress of the vertical elastic element.

In embodiments, said tilt plane substantially coincides with a parasagittal plane of the person when the supporting exoskeleton is worn by said person, and the adjacent exoskeleton vertebra elements are configured for stopping said tilting comprises that the adjacent exoskeleton vertebra elements are configured for stopping said tilting in a forward direction with respect to said person. It is an advantage of these embodiments that the bending of the back spine of the person may be limited in a forward direction, for example, when picking up an object.

In embodiments, the adjacent exoskeleton vertebra elements, each connected to the vertical clastic element at a location, wherein the two locations are separated by a distance, or each integrated in the vertical elastic element at locations separated by a distance, are configured for limiting a bend angle of the vertical elastic element divided by the distance to at most 2°/cm, preferably at most 1°/cm, more preferably at most 0.5°/cm, even more preferably at most 0.3/cm. In embodiments, the predetermined maximum tilt angle divided by the distance is at most 2°/cm, preferably at most 1°/cm, more preferably at most 0.5°/cm, even more preferably at most 0.3/cm. In embodiments, the predetermined maximum tilt angle, divided by a distance between the centres of the adjacent exoskeleton vertebra elements, is at most at most 2°/cm, preferably at most 1°/cm, more preferably at most 0.5°/cm, even more preferably at most 0.3°/cm. In embodiments, the predetermined maximum tilt angle is at most 10°, preferably as at most 5°, more preferably at most 2°, such as from 1° to 10°, and a distance between the centres of the adjacent exoskeleton vertebra elements, such as of each pair adjacent exoskeleton vertebra elements, is from 1 cm to 10 cm. Said distance between the centres may be assumed to be substantially equal to the distance between two positions on the vertical elastic element to which the adjacent exoskeleton vertebra elements are connected. Said distance between the centres may assumed to be substantially equal to a distance between two corresponding locations on the adjacent exoskeleton vertebra elements. In embodiments, the intermittent support comprises at least three, e.g. at least four, e.g. at least five exoskeleton vertebra elements. More exoskeleton vertebra elements may allow for more accurate local limitation of the predetermined maximum tilt angle. In embodiments, the intermittent support comprises at most fifty, such as at most twenty, preferably at most ten exoskeleton vertebra elements. Less exoskeleton vertebra elements may allow for more easy manufacturing and easier personalization of the predetermined maximum tilt angle.

In embodiments, the predetermined maximum tilt angle of each pair of adjacent exoskeleton vertebra elements is substantially independent of a tilt angle of other pairs of adjacent exoskeleton vertebra elements. It is an advantage of these embodiments that the predetermined maximum tilt angle of each pair of adjacent exoskeleton vertebra elements is fixed.

In embodiments, a tilt angle between the adjacent exoskeleton vertebra elements is limited to the predetermined maximum tilt angle. In embodiments, the tilt angle between the adjacent exoskeleton vertebra elements is with respect to an angle between the adjacent exoskeleton vertebra elements in a situation wherein the intermittent support, and typically also the vertical elastic element, is unbended, i.e., straight. In other words, when the intermittent support is linear, i.e., in a neutral position, a tilt angle between adjacent exoskeleton vertebra elements may be zero.

In embodiments, the predetermined maximum tilt angle may be the same for each pair of adjacent exoskeleton vertebra elements. In different embodiments, the predetermined maximum tilt angle may be different for each pair of adjacent exoskeleton vertebra elements. It is an advantage of these embodiments that the predetermined maximum tilt angle of the vertical elastic element, and hence of the spine of the person, may be smaller in regions along the spine that are subject to injuries at a smaller bend angle, i.e., at a larger bend radius. For example, preferably, the bending of the lower back is limited, while at the same time bending at the hip may still be possible and might even be encouraged by limiting the tilt angle along the lower back.

It is an advantage of embodiments of the present invention that each pair of adjacent exoskeleton vertebra elements locally limits bending of the vertical elastic element. By limiting the tilt angle of adjacent exoskeleton vertebra elements independently of each other, local overstretching may be prevented. The supporting exoskeleton may prevent too large local flexion angles for the spine of the person, e.g., so that bending at the lower back (that is most sensitive to injuries) may be initially limited, thereby preventing injuries to the lower back, while bending at the higher back is still possible.

The vertical elastic element is not limited to any shape. The vertical elastic element typically comprises an elongated structure, for example having a length along an elongated axis that is at least 3 times, preferably at least 5 times, more preferably at least 10 times larger than a width in a direction, e.g., each direction, perpendicular to the elongated axis. For example, the vertical elastic element may comprise at least one beam or rod, for example consist of one beam or rod. In some embodiments, the vertical elastic element may comprise many beams or rods. In embodiments, the supporting exoskeleton may be configured so that the vertical elastic element is orientated such that the elongated axis is positioned along a back spine of the person, e.g., substantially parallel to a spine of the person, when the person wears the supporting exoskeleton. In embodiments, the vertical elastic element has a bending stiffness, for bending In embodiments, the vertical elastic element is formed of a material having a Young's modulus of at least 1 GPa, preferably at least 10 GPa, more preferably at least 40 GPa. In embodiments, the vertical elastic element is formed of a plastic, an elastomer, a carbon fiber, a metal, an alloy or a glass fiber, although the invention is not limited thereto. In preferred embodiments, the vertical elastic element is a rod made of carbon fiber or glass fiber. It is an advantage of these embodiments that carbon fiber and glass fiber are strong, flexible, and yet light-weight materials.

In embodiments wherein one or more, e.g. each, exoskeleton vertebra element, is being coupled to the vertical elastic element, such coupling comprises that the exoskeleton vertebra element is at least in contact with the vertical elastic element when the vertical elastic element along the exoskeleton vertebra element is bent. It is an advantage of embodiments of the present invention that the intermittent support provides support to the vertical elastic element when the latter is bended. In embodiments, the connection between each exoskeleton vertebra element and the vertical elastic element may be a slidable connection, such that the intermittent support may be slidable along the vertical flexible element. For example, the vertical flexible element may be movable through apertures comprised in the exoskeleton vertebra elements. It is an advantage of these embodiments that straightforward assembling of the supporting exoskeleton may be achieved. It is a further advantage of these embodiments that there is no, e.g., fixed or hinged connection between each exoskeleton vertebra element and the vertical elastic element that may become strained, for example, when the intermittent support and the vertical elastic element are bended. Alternatively, each exoskeleton vertebra element and the vertical elastic element may be connected by, for example, a fixed connection, a revolute connection, i.e., rotatable, or a hinged connection, the invention not being limited thereto.

In embodiments, adjacent exoskeleton vertebra elements are connected to each other via a revolute joint, preferably a hinge joint. In other words, adjacent exoskeleton vertebra elements may be rotatably, or hingedly, connected with each other. Revolute and hinge joints may provide good long term stability to the connections, and may provide reproducible tilting. Hinge joints enable tilting substantially only in a single direction, so that the tilting occurs substantially only in the tilt plane, e.g., in the parasagittal plane of the person wearing the supporting exoskeleton. This may further prevent back injuries, which may occur, for example, by tilting in a plane different from the parasagittal plane. In embodiments, the tiltable connection between adjacent exoskeleton vertebra elements comprises the vertical clastic element. In these embodiments, the adjacent exoskeleton vertebra elements may be connected to each other via the vertical elastic element. Alternatively worded, the exoskeleton vertebra elements and vertical element are integrated with each other so that the connection between the exoskeleton vertebra elements is performed by the vertical elastic element. For example, the exoskeleton vertebra elements may be directly, e.g., fixedly, connected on the vertical elastic element. In these embodiments, the tilting of adjacent exoskeleton vertebra elements directly corresponds with local bending of the vertical elastic element between the positions on the vertical elastic element to which the adjacent exoskeleton vertebra elements are connected. It is an advantage of these embodiments that material that is required for the supporting exoskeleton may be limited, which may further limit a weight of the supporting exoskeleton.

In embodiments, each exoskeleton vertebra element comprises a projecting element, wherein the projecting elements of adjacent exoskeleton vertebra elements are connected by a spring, a rod, e.g., a flexible rod, a screw, or a cable, although the invention is not limited thereto. Said connection is configured to limit a distance between the projecting element. Said connection is preferably a cable. Said cable is typically unstretched in a situation wherein the intermittent support is straight, or in other words, wherein the tilt angle between adjacent exoskeleton vertebra elements is zero. In these embodiments, the intermittent support may be configured so that said stopping of the tilting, at the predetermined maximum tilt angle, occurs by stretching of the cable. When the cable becomes stretched, the adjacent exoskeleton vertebra elements are not able to tilt further, thereby providing a relatively simple yet reliable way of imposing the limitation on the tilting angle, i.e., the predetermined maximum tilt angle. The predetermined maximum tilt angle being determined by the length of the cable enables that personalization may be straightforward. The means for changing said predetermined maximum tilt angle may comprise means for adapting the length or the stretch of the cable. Furthermore, locally varying predetermined maximum tilt angles (e.g., a predetermined maximum tilt angles that is different for different pairs of adjacent exoskeleton vertebra elements) may be easily implemented by using different cable lengths connecting different pairs of adjacent exoskeleton vertebra elements. In embodiments, the cable may be formed of an elastic material, such as nylon or rubber. It is an advantage of these embodiments that, when the predetermined maximum tilt angle is reached, i.e., when the cable is stretched, slight overstretching is possible, which may provide a more natural feeling to the bending of the supporting exoskeleton. Alternatively, the cable may be formed of a rigid element, such as metal (e.g., a chain of metal rings). It is an advantage of these embodiments that no tilting beyond the predetermined maximum tilt angle is possible even when a large force is exerted on the supporting exoskeleton, thereby further preventing detrimental overbending of the vertical elastic element. In embodiments, the exoskeleton vertebra elements are formed of a rigid material, preferably of a metal or of a carbon fibre. Rigid exoskeleton vertebra elements may further prevent overbending of the vertical elastic element.

In embodiments, in a situation wherein the intermittent support is linear, adjacent exoskeleton vertebra elements are separated from each other by a gap, and the intermittent support is configured for reducing a magnitude of said gap when tilting, for example in the forward direction, and may be configured for stopping said tilting, for example in the forward direction, when the gap is closed, i.e., when the adjacent exoskeleton vertebra elements collide into each other. In embodiments, at least one surface, e.g., both surfaces, defining the gap is formed of a flexible material, such as a rubber or an elastomer. In embodiments, the exoskeleton vertebra elements are substantially formed of a rubber or an elastomer. It is an advantage of these embodiments that an operation of the supporting exoskeleton may be achieved that may be perceived as more natural to the person wearing the supporting exoskeleton.

In embodiments, each exoskeleton vertebra element comprises means, e.g., a screw or an actuator, adapted for changing a magnitude of the gap. This enables relatively simple and swift adjustment of the gap, thereby adjusting the angle at which tilting is stopped. Alternatively, inserts may be used to adapt the magnitude of the gap.

In embodiments, each exoskeleton vertebra element comprises an inflatable actuator, configured to switch between a flexible state and a rigid state. In these embodiments, the intermittent support may comprise an array of inflatable actuators. In these embodiments, adjacent exoskeleton vertebra elements may touch each other or be connected with each other. For example, the inflatable actuator may be an inflatable balloon, e.g., an inflatable elastomer balloon. Said inflation, and possibly also deflation, may be performed by an air pump that is present in the supporting exoskeleton. For example, the inflation may be activated by a person when he is about to lift an object or by an automatic mechanism, so that the inflatable actuator is switched to a stiffer state. Subsequently, the inflatable actuator may be deflated when the person has moved the object, and is not about to lift a further object, so that the inflatable actuator is switched to a compliant state. These embodiments may provide maximum flexibility for the person, wherein, in the stiffer state, tilting is stopped at the predetermined maximum tilt angle, and in the compliant state, tilting is not limited by the predetermined maximum tilt angle. It is an advantage of these embodiments that, in the flexible state, movement of the person may be less constrained by the supporting exoskeleton.

The system may comprise a stiffness controller for controlling the stiffness of the system. Such a stiffness controller may be operated manually or in an automated way, based on predetermined algorithms or based on a self learning system, e.g. through neural networks. The variable stiffness may be obtained by controlling a degree of inflation of the inflatable actuators or by controlling a tension in a cable in the system, as illustrated in embodiments of the present invention. In some embodiments, the mechanism can be used to adjust the stiffness, i.e. the torque needed to change the bending/tilting at different tilting angles.

It is an advantage of embodiments of the present invention that the system also can act as a variable stiffness actuator, allowing to control the stiffness. The latter can be obtained using the different implementations mentioned above and/or shown below, such as for example in embodiments based on cable tension or in embodiments based on pneumatic inflatable actuators such as balloons. The latter also may be referred to as a PAM (pneumatic artificial muscle).

Any features of any embodiment of the first aspect may be independently as correspondingly described for any embodiment of any of the other aspects of the present invention.

In a second aspect, the present invention relates to a supporting exoskeleton comprising a rigid main body, and a hip engagement member for engagement of the rigid main body with a hip of a person when wearing the supporting exoskeleton. The supporting exoskeleton further comprises a first lower member and a second lower member. The first lower member is rotatably attached to the main body such that an axis of the rotation of the first lower member substantially coincides with an axis of a rotation of a left hip joint of said person, and comprises a left leg engagement member for engagement with a left leg of said person. The second lower member is rotatably attached to the main body such that an axis of the rotation of the second lower member substantially coincides with an axis of a rotation of a right hip joint of said person, and comprises a right leg engagement member for engagement with a right leg of said person. Where in embodiments reference is made to substantially coinciding axes of rotation, reference is made to a situation wherein the axes of rotation preferably coincide or wherein the distance between the axis of rotation of the hip joint and the low member is sufficiently small at the position of the hip, so that the system can compensate for small misalignments that are induced. The supporting exoskeleton further comprises a differential coupler, which may be attached to said main body, and that is adapted for, in an engagement mode of the differential coupler, differentially coupling the rotation of the first lower member to the rotation of the second lower member. The differential coupler is preferably located at the hip level of said person, which may provide efficient coupling between movement of the legs. Said differential coupling typically comprises that the rotation of the first lower member is in an opposite sense with respect to the rotation of the second lower member. In other words, as one leg is moved forward, the mechanism may move the contralateral leg back and vice versa. By allowing for opposing movements of the legs, healthy walking can be approximated without major loads on the legs or pelvis (thus allowing to walk freely). The supporting exoskeleton further comprises a vertical elastic element, preferably configured to be located along a back spine of said person, and an upper torso engagement member for engagement with an upper part of a torso of said person, wherein the vertical elastic element is coupled to the upper torso engagement member, and fixedly coupled, e.g., at a distal end, to the main body. Such a coupling may be a hinged coupling, an clastic coupling, a rotative coupling, a coupling allowing a sliding motion in between the elastic element and the engagement member, etc. The clastic element typically also may be coupled to the torso engagement member. Such a coupling may be a hinged coupling, an clastic coupling, a rotative coupling, a coupling allowing a sliding motion in between the clastic element and the engagement member, etc. The coupling may for example be hingedly, rotatively and/or slidingly. This configuration may provide an efficient and naturally feeling transfer of forces from the upper torso to the legs. Typically, the supporting exoskeleton has contact points in at least three regions of the person's body: at the torso level (by the upper torso engagement member), at the hip level (by the rigid main body), and at the upper leg level (by the lower members). It is an advantage of embodiments of the present invention that, by fixing the vertical clastic element with respect to the first and second lower member (i.e., via the rigid main body), force may be efficiently transferred from the torso to the legs of the person. It is an advantage of embodiments of the present invention that if any torque is put on the supporting exoskeleton, e.g., on the vertical clastic element while the person wearing the supporting exoskeleton lifts an object, the resulting forces are automatically distributed over both legs equally. In preferred embodiments, the differential coupler is switchable to a disengagement mode, comprising disengaging the movement of the first lower member and the movement of the second lower member. The differential coupler may be switched between an engagement mode and a disengagement mode by means of a mechanical switch or button which mechanically disengages the two parts of the mechanism that are normally in contact. For example, disengagement/re-engagement may be based on movement of two gears, or by removing the connection between any of the gears and the axis it is revolving around. The latter may for example be implemented using a brake mechanism increasing the friction between the two elements to engage and releasing the friction to disengage, or for example using a ratchet-and-pawl mechanism providing a mechanical stop to ensure engagement, which can be removed for disengagement. It could also be implemented using an overrunning clutch which uses balls to couple both parts together. In another exemplary embodiment, this may be magnetic parts that are pushed into place by means of a mechanical switch or button which then by magnetic force couple both parts together. Although the embodiments above refer to a direct mechanical link, also alternatives making use of an electrical signal may be used. For example, a button may provide an electrical signal, causing a servo motor or any other actuated component to engage or disengage in a similar way as described above. It is an advantage of these embodiments that a transparent mode of operation is possible, enabling to user to move, e.g., sit down and climb stairs or ladders, without any interference to his legs or torso. Furthermore, by switching the differential coupler itself between engagement mode and disengagement mode, only one disengagement mechanism is required rather than one for each leg. In embodiments, the differential coupler may be switched between the engagement mode and the disengagement mode by a clutching element, preferably via a single clutching element. The present invention may provide for a differential coupler that requires no more than the single clutching element. The clutching element may comprise an electronically controlled actuator for performing said switching. In other words, the electronically controlled actuator may switch the differential coupler between the engagement mode and the disengagement mode.

In embodiments, the switching may be activated (i.e., the command for performing the switching may be generated) by the person wearing the supporting exoskeleton, for example, by pressing a button, switching a lever or a switch, moving a mechanical part manually in a different way or by a voice-controlled mechanism. In embodiments, activation of the switching may be determined based on an algorithm. Said algorithm may receive information on movements of the person wearing the supporting exoskeleton, and determine, based on said information, whether the switching is to be activated.

Automatic switching may be based on kinematic measurements, e.g. thereby determining what the user wants to do: if the user wants to walk or sit down, disengagement may be done, if the user starts to bend over to pick up an object, engagement may be done. It is an advantage of these embodiments that the differential coupler may be switched without interfering with a movement of the person, and without hindrance, such that switching may be performed even while lifting, holding or carrying an object.

It is an advantage of embodiments of the present invention that when using an automatic system, the user does not need his hands to push a button. In this way, the system can be engaged/disengaged when the person is holding or carrying an object.

Any features of any embodiment of the second aspect may be independently as correspondingly described for any embodiment of any of the other aspects of the present invention. In embodiments of the second aspect, the supporting exoskeleton of the second aspect is a supporting exoskeleton in accordance with embodiments of the first aspect.

In embodiments, the differential coupler may comprise a geared system. The geared system may in one embodiment be a typical bevel-gear differential, e.g. having two bevel gears one on each side, and 1 or 2 bevel gears in between, which couple and invert the motion of the two bevel gears on the side. In these embodiments, the rotation of the first lower member is, in an engagement mode, differentially coupled to the rotation of the second lower member by gears. For switching the differential coupler to disengagement mode, a mechanically or electronically controlled actuator may decouple one of the gears in the geared system, thereby decoupling movement of the first lower member and the second lower member.

In embodiments, the differential coupler may comprise a flexible shaft, connected to first gears located at a left hip of the person and to second gears located at a right hip of the person, wherein the first gears and the second gears are configured for generating a differential coupling between the first lower member and the second lower member. For switching the differential coupler to disengagement mode, an electronically controlled actuator may decouple one of the first and second gears. In an exemplary embodiment thereof, the differential mechanism is split and placed on either side of the user and coupled together with the flexible shaft.

In different embodiments, the differential coupler may comprise a cable-pulley system, comprising a first cable coupled to the first lower member via a first pulley located at a left hip of the person and a second cable coupled to the second lower member via a second pulley located at a right hip of the person. The pulleys being located at the hips of the person may result in a natural feeling for the differential coupling, and an efficient transfer of force between the legs. The first and second cable may be directly connected with each other, so that the first cable runs over in the second cable, e.g., so that the first and second lower member are coupled to each other via a single cable. Alternatively, the first and second cable may be different cables. In embodiments, the differential coupled is configured for, in the disengagement mode, reducing a tension in at least one of the cables compared to a tension in the engagement mode. It is an advantage of these embodiments that this enables for simple switching between engagement and disengagement mode. In embodiments, the first and second cable are connected via the clutching element. In embodiments, the clutching element is a non-backdrivable lead screw, coupled to an actuator, configured for changing the tension in the cable. It is an advantage of these embodiments that a simple mechanism may be obtained that both provides good coupling, and facile switching between the engagement and disengagement mode. In embodiments, the first cable may be coupled to the second cable via two further pulleys, different from the first and second pulley, wherein the two further pulleys are connected to each other. In these embodiments, an end of the first cable may be fixed to the main body and an end of the second cable may be fixed to the clutching element, that is, in turn, fixed to the main body. It is an advantage of these embodiments that the clutching element is fixed and may not move while transferring movement between the lower members. The clutching element may be relatively heavy (at least compared to the first and second cable). Fixing the clutched member may result in a low movement of mass when the cables are moved during the coupling of movements of the legs (e.g., when one leg moves forward, the other is induced to move backward), e.g., lower than when the clutched member moves along with the cables, which consequently may result in a low loss of energy due to the differential coupling. In embodiments, the cable comprises, for example, metal, natural fibers, or polymers. Preferably, the cable is formed of metal.

In embodiments, the differential coupler comprises an elastic coupling between the first and second lower member. Preferably, means for the elastic coupling are located in the differential coupler. Only a single elastic coupling means, e.g., only a single spring or only a single elastic rope, may be required for obtaining the differential coupler. For example, in embodiments comprising the first and second cable, the first and second cable may be coupled to each other via a spring. An elastic coupling may allow for good accommodation of typical movements of the legs with respect to each other.

In embodiments, the supporting exoskeleton is adapted such that the vertical elastic element is located along a back, preferably along a back spine, and substantially contained in a parasagittal plane, preferably with a median plane, of the person when the supporting exoskeleton is worn by the person. In embodiments, the vertical elastic element is a rod made of plastic, elastomer, carbon fiber or glass fiber. Carbon and glass fiber are typically strong, flexible, and light-weight materials.

In embodiments, the hip engagement member comprises a belt assembly. Belt assemblies may be easy to implement and may enable good engagement of the supporting exoskeleton, i.e., of the rigid main body, with the hip of the person.

In embodiments, the left and right leg engagement members are adapted for engaging with a left front upper leg and a right front upper leg, respectively, of the person. When the person wearing the supporting exoskeleton bends forward for picking up an object, torque transferred to the legs is mostly transferred to the front upper leg (not, e.g., to the back leg).

It is an advantage of at least some embodiments of the present invention that a mechanism is provided which effectively can couple the movement of both legs together. According to some embodiments, by allowing for opposing movements of the legs, healthy walking can be approximated without major loads on the legs or pelvis (thus allowing to walk freely).

In some embodiments, the legs are directly coupled together using a flexible shaft using opposing gear ratios at each of the hips using a reduction to reduce the torques in the mechanism.

In one particular embodiment, the exoskeleton attaches to the body at the chest, the belt and the legs. Both legs can be connected together through a worm gear differential and flexible shaft. The structure can be connected to the chest interface through carbon fiber beams.

In a particular embodiment, the gearing mechanism and flexible shaft has been mounted so the rotation of both legs are coupled and inverted (i.e. when one leg rotates forward, the other leg rotates backward). In one particular implementation, the worm gear is connected to the leg interface, while the worm is connected to the flexible shaft, in turn connected to the contralateral worm.

In a third aspect, the present invention relates to a method for making the supporting exoskeleton in accordance with embodiments of the first aspect or second aspect. The method comprises obtaining the different parts, and assembling said parts so as to form the supporting exoskeleton.

Any features of any embodiment of the third aspect may be independently as correspondingly described for any embodiment of any of the other aspects of the present invention.

In a fourth aspect, the present invention relates to a use of the supporting exoskeleton in accordance with embodiments of the first or second aspect for lifting an object.

Any features of any embodiment of the fourth aspect may be independently as correspondingly described for any embodiment of any of the other aspects of the present invention.

Particular and preferred aspects of the invention are set out in the accompanying independent and dependent claims. Features from the dependent claims may be combined with features of the independent claims and with features of other dependent claims as appropriate and not merely as explicitly set out in the claims.

Although there has been constant improvement, change and evolution of devices in this field, the present concepts are believed to represent substantial new and novel improvements, including departures from prior practices, resulting in the provision of more efficient, stable and reliable devices of this nature.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 is a schematic representation of a vertical elastic element, and of an intermittent support 2, uncoupled to each other.

FIG. 2 is a schematic representation of the vertical elastic element and the intermittent support of FIG. 1, coupled to each other.

FIG. 3 is a schematic representation of a vertical elastic element, and an intermittent support of a supporting exoskeleton in accordance with embodiments of the present invention.

FIG. 4 is a schematic representation of a vertical elastic element, and an intermittent support in accordance with embodiments of the present invention.

FIG. 5 is a side view of a schematic representation of a supporting exoskeleton in accordance with embodiments of the present invention.

FIG. 6 is a diagram of the torque exerted on the vertical elastic element of FIG. 5, as dependent on bend angle of the vertical elastic element.

FIG. 7 is a schematic representation of a supporting exoskeleton in accordance with embodiments of the present invention, worn by a person.

FIG. 8 is a schematic representation of a supporting exoskeleton in accordance with embodiments of the present invention.

FIG. 9A-E are schematic representations of different implementations of cable-pulley systems, i.e., differential couplers, in accordance with embodiments of the present invention.

FIG. 10 is a schematic representation of a supporting exoskeleton comprising a differential coupler according to embodiments of the present invention

In the different figures, the same reference signs refer to the same or analogous elements.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. The term “comprising” therefore covers the situation where only the stated features are present and the situation where these features and one or more other features are present. The word “comprising” according to the invention therefore also includes as one embodiment that no further components are present. Thus, the scope of the expression “a device comprising means A and B” should not be interpreted as being limited to devices consisting only of components A and B. It means that with respect to the present invention, the only relevant components of the device are A and B.

Similarly, it is to be noticed that the term “coupled”, also used in the claims, should not be interpreted as being restricted to direct connections only. The terms “coupled” and “connected”, along with their derivatives, may be used. It should be understood that these terms are not intended as synonyms for each other. Thus, the scope of the expression “a device A coupled to a device B” should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

In the context of the present invention, it is understood that definitions and/or explanations of features of the supporting exoskeleton in relation to a person are typically applicable when said person is wearing the supporting exoskeleton in the indicated way.

As used in the context of the present invention, the bend radius, e.g., the (two-dimensional) radius of curvature as known in the art, of (a portion of) the vertical elastic element is understood to be the radius of a circle that best fits a normal section of an inner surface of (the portion of) the vertical elastic element.

The invention will now be described by a detailed description of several embodiments of the invention. It is clear that other embodiments of the invention can be configured according to the knowledge of persons skilled in the art without departing from the technical teaching of the invention, the invention being limited only by the terms of the appended claims.

In a first aspect, the present invention relates to a supporting exoskeleton. The supporting exoskeleton comprises a vertical elastic element, and an intermittent support. Optionally, the supporting exoskeleton also comprises hip engagement members and an upper torso engagement member. The vertical elastic element is coupled to a hip engagement member for engagement with a hip of a person, and to the upper torso engagement member for engagement with an upper part of a torso of said person. The intermittent support comprises a plurality of exoskeleton vertebra elements positioned along a portion of the vertical elastic element. Alternatively, the intermittent support may be integrated with the vertical elastic element, so that the plurality of exoskeleton vertebra elements are coupled to each other by the vertical elastic element. At least said portion of the vertical elastic element is adapted to be positioned along a back spine of said person when wearing the supporting exoskeleton. At least one or more exoskeleton vertebra elements, or e.g. each of the exoskeleton vertebra elements, is connected to or through the vertical elastic element, wherein adjacent exoskeleton vertebra elements are tiltably connected with each other, wherein the tilting is in a tilt plane. In embodiments, each pair of adjacent exoskeleton vertebra elements is configured for stopping said tilting in the tilt plane at a predetermined maximum tilt angle, such that bending, in the tilt plane, of the vertical elastic element along the pair of adjacent exoskeleton vertebra elements is limited to a bend radius of at least 50 cm.

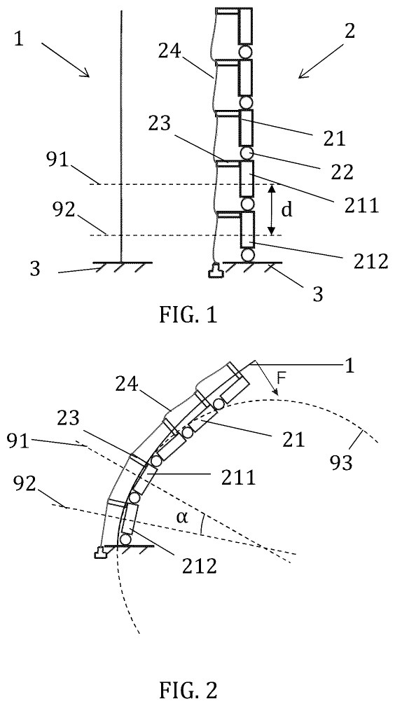

Reference is made to FIG. 1, which is a schematic representation of a vertical elastic element 1, and an intermittent support 2, that are, in this schematic representation, uncoupled with respect to each other for clarity reason. Both are, at one end, fixed to ground 3. The vertical elastic element 1 in this example consists of a beam, i.e., a rod. The intermittent support 2 comprises, in this example, five exoskeleton vertebra elements 21, that, in this example, are formed of a rigid material, e.g. metal. Adjacent exoskeleton vertebra elements 21 are tiltably connected with each other via a hinge 22. In this example, each exoskeleton vertebra element 21 comprises a projecting element 23. The projecting elements 23 of adjacent exoskeleton vertebra elements 21 are connected to each other by a cable 24. In a situation wherein the vertical elastic element 1 and the intermittent support 2 are straight—as shown in FIG. 1—the cables are unstretched.

In said situation, the tilt angle between exemplary adjacent exoskeleton vertebra elements 211 and 212 is zero, and the bend radius of the vertical elastic element 1 is infinite. The bend angle of the vertical elastic element 1 along exemplary adjacent exoskeleton vertebra elements 211 and 212 may be determined by drawing two lines 91 and 92 perpendicular to the long axis of the elastic element 1, and intersecting with corresponding locations on (in this example assumed to be the centers of) the exemplary adjacent exoskeleton vertebra elements 211 and 212, that are in the supporting exoskeleton coupled to each other (cfr. FIG. 2). The angle between the lines 91 and 92 is zero degrees, and so is the bend angle. The tilt angle between the exemplary adjacent exoskeleton vertebra elements 211 and 212 is also zero. The distance d between the centers of the exemplary adjacent exoskeleton vertebra elements 211 and 212, preferably determined in said (straight) situation, is the distance between the lines 91 and 92.

Reference is made to FIG. 2, which is a schematic representation of the vertical elastic element 1 and the intermittent support 2 of FIG. 1, forming part of a supporting exoskeleton in accordance with embodiments of the present invention. The plurality of exoskeleton vertebra elements 21 are positioned along a portion, in this example largest part, of the vertical elastic element 1. Each exoskeleton vertebra element 21 is coupled to the vertical elastic element 1. In this example, each exoskeleton vertebra element 21, more specifically each projecting element 23, comprises an aperture, and the vertical elastic element 1 extends through the apertures of the exoskeleton vertebra elements 21. The vertical elastic element 1 is, in this example, not fixed to the exoskeleton vertebra elements 21, so may slide through the apertures. As such, the coupling is a sliding coupling. Due to the sliding coupling, when the vertical elastic element 1 is bended, less stress may be exerted on the vertical elastic element 1 along the extended axis of the vertical elastic element 1. Alternatively, the coupling may be a fixed connection.

The vertical elastic element 1 may be coupled to a hip engagement member adapted for engaging with a hip of a person, and an upper torso engagement member for engaging with an upper torso of said person (not shown), so that the person wears the supporting exoskeleton. Said coupling is preferably through a connection directly with the vertical elastic element 1, but may instead be via the intermittent support 2. In this example, the person wears the supporting exoskeleton such that, when the person bends forward (corresponding to force F exerted on the vertical elastic element 1 in FIG. 2), the vertical elastic element 1 and the intermittent support 2 bend to the right. As such, the tilt plane is in the plane of the paper. When bending, the tilt angle between adjacent exoskeleton vertebra elements 21 may become larger than zero. Each projecting element 23 projects in a direction away from the person wearing the supporting exoskeleton. Said tilting, and hence the bending, between two adjacent exoskeleton vertebra elements 21 is stopped at a predetermined maximum tilt angle, that occurs when the cable 24 connecting the adjacent exoskeleton vertebra elements 21 is stretched. Said predetermined maximum tilt angle for each pair of adjacent exoskeleton vertebra elements 21 is independent of the tilt angle of different pairs of adjacent exoskeleton vertebra elements 21. Thereby, bending of the vertical elastic element 1 along each pair of adjacent exoskeleton vertebra elements 21 is limited to the predetermined bend radius.

The angle between the lines 91 and 92, perpendicular to the clastic element 1, and intersecting with corresponding locations on the adjacent exoskeleton vertebra elements 211 and 212, is now nonzero degrees, i.e., α. The adjacent exoskeleton vertebra elements 211 and 212 have tilted, with respect to each other, over the same angle α, so their tilt angle is equal to α. The bend radius, which is the radius of a circle 93 (of which here only part is shown) contained in the tilt plane and fitted to a normal section of an inner surface of the portion of the vertical elastic element along the adjacent exoskeleton vertebra elements 211 and 212, is no longer infinite in this example.

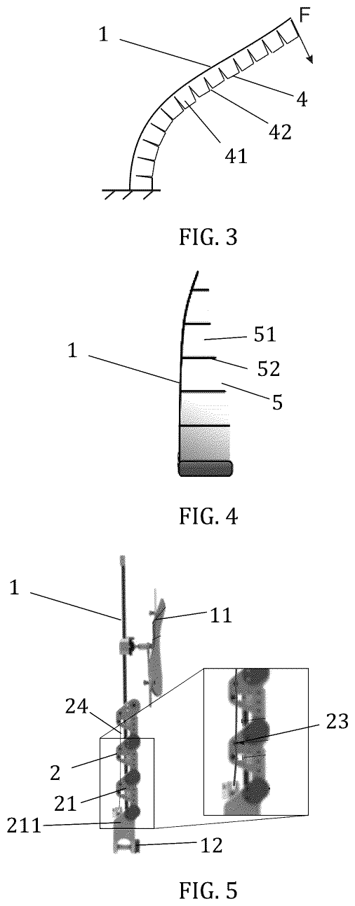

Reference is made to FIG. 3, which is a schematic representation of a vertical elastic element 1, and an intermittent support 4 of a supporting exoskeleton in accordance with embodiments of the present invention. In this example, the intermittent support 4 comprises, in this example, fourteen exoskeleton vertebra elements 41 positioned along the full length of the vertical elastic element 1. Each exoskeleton vertebra elements 41 is fixed on the vertical elastic element 1, projecting in a direction towards a person wearing the supporting exoskeleton, such that adjacent exoskeleton vertebra elements 41 are tiltably connected with each other via the vertical elastic element 1. In a situation wherein the vertical elastic element 1 and the intermittent support 4 are straight, adjacent exoskeleton vertebra elements 42 are separated by a gap 43. When bending the vertical elastic element 1, to the right in FIG. 3, which is typically in a forward direction of the person wearing the supporting exoskeleton, such that the adjacent exoskeleton vertebra elements 41 tilt with respect to each other, said gap may become smaller. When the gap is closed, i.e., when the adjacent exoskeleton vertebra elements collide into each other, the predetermined maximum tilt angle between the adjacent exoskeleton vertebra elements 41 may be reached, and tilting (and bending of the vertical elastic element along the pair of adjacent exoskeleton vertebra elements) is stopped.

Reference is made to FIG. 4, which is a schematic representation of a vertical elastic element 1, and an intermittent support 5 of a supporting exoskeleton in accordance with embodiments of the present invention. The intermittent support 5 comprises, in this example, six exoskeleton vertebra elements 51 (which are only partially shown in FIG. 4), each exoskeleton vertebra element 51 comprising an inflatable actuator 51, being, in this example, an inflatable elastomer 51, which projects in a direction towards a person wearing the supporting exoskeleton. As such, the intermittent support 5 comprises, in this example, an array of inflatable elastomers 51. The inflatable elastomers 51 are separated from each other by separators 52 that may be formed of carbon/glass fiber.

Reference is made to FIG. 5, which is a side view of a schematic representation of a supporting exoskeleton in accordance with embodiments of the present invention. The right part of FIG. 5 is an exploded view of the section indicated by the rectangle of the left part of FIG. 5. A vertical elastic element 1 is connected to an upper torso engagement member 11 and, in this example at a distal end, to a hip engagement member 12 (only partially shown in FIG. 5). An intermittent support 2 comprises, in this example, four exoskeleton vertebra elements 21, of which one exoskeleton vertebra element 211 is fixed to the to the hip engagement member 12. The vertical clastic element 1 extends to apertures of the exoskeleton vertebra elements 21, so that the exoskeleton vertebra elements 21 are slidingly coupled to the vertical elastic element 1.

Tilting between adjacent exoskeleton vertebra elements 21 is limited, in a right direction in FIG. 5, e.g., in a forward direction with respect to a person wearing the supporting exoskeleton, by a cable 24. The cable is fixed at a projecting part 23 of each of the exoskeleton vertebra elements 21, the projecting part 23 projecting away from a person wearing the supporting exoskeleton. In this example, the cable is flexible and is pretensioned. When stretched, the cable becomes rigid, and the predetermined maximum tilt angle is reached.

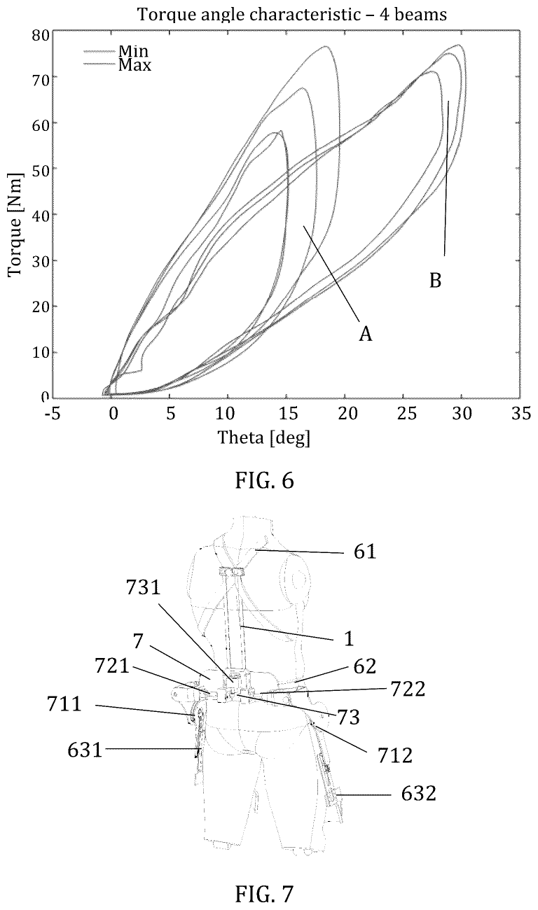

Reference is made to FIG. 6, which is a diagram of the torque exerted on the vertical elastic element of FIG. 5, as dependent on bend angle of the vertical elastic element, wherein the maximum tilt angle for adjacent exoskeleton vertebra elements of the intermittent support is differed by changing the pretension of the cable connecting the adjacent exoskeleton vertebra elements. The predetermined maximum tilt angle of the adjacent exoskeleton vertebra elements correlates with said bend angle. For curve A, the cables are more pretensioned than for curve B, resulting in stiffer behaviour of the intermittent support and vertical elastic element related to curve A. For equal applied torque, the bending angle is much smaller for curve A than for curve B. The maximum bend angle is where the torque to be exerted to achieve further bending strongly increases: for curve A, this is at about 13°; for curve, this is at about 30°. Hence, the maximum bend angle, and also the tilt angle at which tilting between the adjacent exoskeleton vertebra elements is stopped, i.e., the predetermined maximum tilt angle, is much smaller for curve A than for curve B.

In a second aspect, the present invention relates to a supporting exoskeleton comprising a rigid main body, and a hip engagement member for engagement of the rigid main body with a hip of a person when wearing the supporting exoskeleton. The supporting exoskeleton further comprises a first lower member and a second lower member. The first lower member is rotatably attached to the main body such that an axis of the rotation of the first lower member substantially coincides with an axis of a rotation of a left hip joint of said person, and comprises a left leg engagement member for engagement with a left leg of said person. The second lower member is rotatably attached to the main body such that an axis of the rotation of the second lower member substantially coincides with an axis of a rotation of a right hip joint of said person, and comprises a right leg engagement member for engagement with a right leg of said person. The supporting exoskeleton further comprises a differential coupler, adapted for, in an engagement mode of the differential coupler, differentially coupling the rotation of the first lower member to the rotation of the second lower member. The supporting exoskeleton further comprises a vertical elastic element and an upper torso engagement member for engagement with an upper part of a torso of said person, wherein the vertical elastic element is coupled to the upper torso engagement member, and fixedly coupled to the main body.

Reference is made to FIG. 7, which is a schematic representation of a supporting exoskeleton in accordance with embodiments of the present invention, worn by a person. The supporting exoskeleton has a first contact point at the torso level of said person, by an upper torso engagement member 61 fixed to a vertical elastic element 1 that, in this example, comprises two beams aligned along the back spine of the person. The supporting exoskeleton has a second contact point at the hip level of said person, by a rigid main body 7, and a hip engagement member 62 for engagement of the rigid main body 7 with a hip of said person. The supporting exoskeleton has a third contact point at the upper leg level, by the first 631 and second lower member 632, that are adapted for engagement with upper front part of the left and right leg of the person, respectively. The lower members 631 and 632 are rotatably attached to the main body 7 such that an axis of the rotation of the lower members substantially coincide with an axis of a rotation of the respective hip joints of said person. Said rotation is coupled to rotation of a pulley 711 and 712 at each hip, around which a first and second cable are wound. The lower members 631 and 632 are differentially coupled with each other. The differential coupling comprises two rods 721 and 722 on the rigid body 7. Each rod is coupled to the pulley on the respective hip via the cable, such that rotation of each lower members 631 and 632 results in rotation of the respective rods 721 and 722 (i.e., located at the same side of the body as the lower member). The rods 721 and 722 are differentially coupled via a geared system 73. The geared system comprises that a gear fixed at the end of each rod 721 and 722. The gears of both rods 721 and 722 are coupled to each other via a further gear, effectively resulting in a differential coupling between the rods 721 and 722 and, hence, between the lower members 631 and 632. An actuator 731 is configured for switching the geared system 73 between an engagement mode and a disengagement mode, by decoupling, in this example, the further gear from the geared system 73. In this example, instead of using the pulleys 711 and 712 and cables connected to the rods 721 and 722, a purely geared system could be used, i.e., wherein the pulleys 711 and 712 are replaced by gears, and coupled to the rods, possibly via further gears.

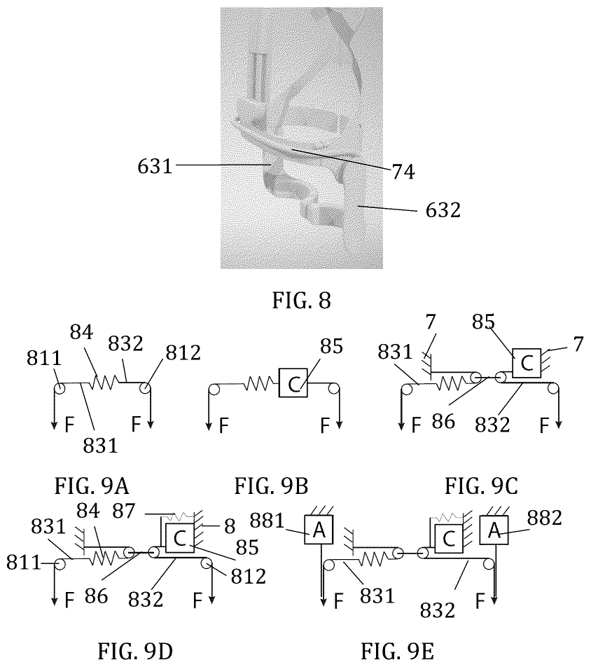

Reference is made to FIG. 8, which is a schematic representation of a supporting exoskeleton in accordance with embodiments of the present invention. In this example, the differential coupler comprises a flexible shaft 74, connected to first gears located at a left hip of the person and to second gears located at a right hip of a person wearing the supporting exoskeleton (not shown). The flexible shaft 74, which may extend through a curved tube, curves past the lower back of the person, enabling coupling between gears located at opposite hips. The first gears and the right gears are configured for generating a differential coupling between the first lower member 631 and the second lower member 632.

Reference is made to FIG. 9A-E, which show different implementations of differential couplers, in this example cable-pulley systems, in accordance with embodiments of the present invention. Reference is made to FIG. 9A. In a simple implementation, two cables 831 and 832 are connected to each other by a spring 84, which is used to introduce flexibility in the differential coupling, which may result in good safety, and may provide a natural feeling. The spring is not essential, however, and instead, a single cable could be used. Each cable 831 and 832 is coupled to a pulley 811 and 812. Movement of each cable 831 and 832 (extending further in the direction of the arrows) is coupled to rotation of the lower member of a respective hip (not shown), such that a differential coupling is obtained.

Reference is made to FIG. 9B. A clutching element 85 may be added for switching between a an engagement mode and a disengagement mode. The clutching element 85 may wind up or loosen cable, thereby increasing or reducing tension in the cables 831 and 832, respectively, so as to switch between engagement mode and disengagement mode, respectively. For example, the clutching element 85 may be based on a spool or, more preferably, a non-backdrivable lead screw, which may result in a simple yet robust implementation. In this example, movement of the clutching element 85 is coupled to movement of the cables 831 and 832.

To reduce movement of mass, and hence consumption of energy by the differential coupling, the clutching element 85 may be fixed to the rigid body member. As such, second cable 832 is connected, via the clutching element 85, to the rigid body member 7. First cable 831 may also be connected to the rigid body member 7, at a different location than the clutching element 85. Coupling between the first 831 and second cable 832 is in this example obtained by a couple of further pulleys 86 that are connected to each other.

Reference is made to FIG. 9D. In order to keep the cables 831 and 832 on the pulleys 811 and 912 and the couple of further pulleys 86 in a disengagement mode, wherein the cables may be under reduced tension, i.e., loosened, the cable 832 connected to the clutching element 85 may be further connected to the rigid body member 7 via a low stiffness spring 87, having a stiffness at least one order of magnitude lower than that of the spring 84.

Reference is made to FIG. 9E. Actuators 881 and 882 may be coupled to the cables 831 and 832, respectively, for facilitating movement of the cables 831 and 832.

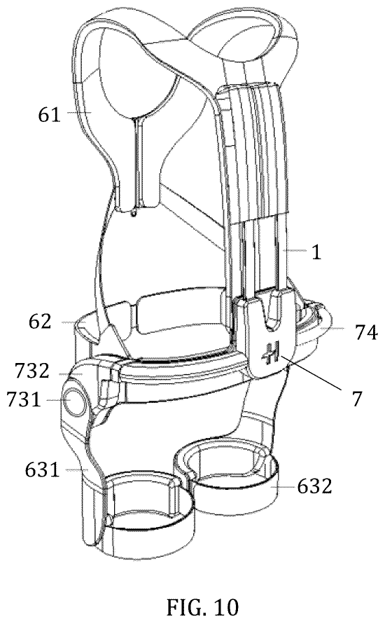

Reference is made to FIG. 10, which is a schematic representation of a supporting exoskeleton comprising a differential coupler according to embodiments of the present invention. The supporting exoskeleton comprises a vertical elastic element 1 fixed to a rigid main body 7. The vertical elastic element 1 is oriented along a back spine of the person, and may therefore be well-position to mimic the bending characteristics of said back spine. The vertical elastic element 1 may be one or more beams, straight or bent, round or rectangular. The vertical elastic element 1 allows for the same bending or deflection as the human hip with respect to the human torso (around) 90°, while providing a support torque which is extending the spine. The torque is typically between 0 and 50 Nm and depends on desired level of assistance, height and weight of the human body etc. . . . .

A hip engagement member 62 is provided for engagement of the rigid main body 7 with a hip of said person. The supporting exoskeleton comprises a flexible shaft in a housing 74 at the hip level of the person. Locating the differential coupler, e.g., the flexible shaft, at the hip level, and possibly fixing the housing 74 comprising the differential coupler to the rigid main body 7, may result in robust and efficient differential coupling. A differential gear box 732 is provided on each side, wherein the flexible shaft is coupled to the gears in the differential gear boxes 732. As such, the flexible shaft is a torsionally flexible element that connects the differential gear box 732 on each side, allowing the gears, and the rotation of the lower members 631 and 632, to be aligned with the hip joints of the person, while connecting the parts of the differential together. These shafts can typically transmit around 0 to 5 Nm of torque. The shaft connects to the gearboxes making a ˜90° angle with respect to the hip axis, allowing it to remain close to the body. Further provided is an actuator 731, i.e., engagement/disengagement means, configured for switching the geared system 732 between an engagement mode and a disengagement mode. In these embodiments, one or two such actuators 731 may be present, one for each side. The engagement/disengagement means, which can be placed either at the level of the differential gear boxes or the flexible shaft, and consists of at least one mechanism able to disconnect both legs from each other. As there is a kinematic chain connecting both legs, one may be sufficient. The mechanism can be placed on the side where it is easily accessible, or at the back of the device. When disengaged, the motion of the legs is no longer coupled together, and no longer connected to the motion of the torso through the vertical elastic element. The mechanism to engage/disengage may comprise different technologies, such as an overrunning clutch blocking or allowing the rotation of the flexible shaft, a ratchet and pawl mechanism, a mechanism using a magnetic force to increase or decrease friction between two rotating parts, the invention not being limited to these examples.

It is to be understood that although preferred embodiments, specific constructions and configurations, as well as materials, have been discussed herein for devices according to the present invention, various changes or modifications in form and detail may be made without departing from the scope of this invention. Steps may be added or deleted to methods described within the scope of the present invention.

1.-15. (canceled)

16. A supporting exoskeleton comprising:
a rigid main body, and a hip engagement member for engagement of the rigid main body with a hip of a person when wearing the supporting exoskeleton,
a first lower member rotatably attached to the main body such that an axis of the rotation of the first lower member substantially coincides with an axis of a rotation of a left hip joint of said person, and comprising a left leg engagement member for engagement with a left leg of said person, and a second lower member rotatably attached to the main body such that an axis of the rotation of the second lower member substantially coincides with an axis of a rotation of a right hip joint of said person, and comprising a right leg engagement member for engagement with a right leg of said person,
a differential coupler, adapted for, in an engagement mode of the differential coupler, differentially coupling the rotation of the first lower member to the rotation of the second lower member,
wherein the vertical elastic element of the supporting exoskeleton is coupled to an upper torso engagement member for engagement with an upper part of a torso of said person, and fixedly coupled to the main body,
wherein the differential coupler comprises a flexible shaft, connected to first gears located at a left hip of the person and to second gears located at a right hip of the person, wherein the first gears and the second gears are configured for generating a differential coupling between the first lower member and the second lower member.

17. The supporting exoskeleton according to claim 16, wherein the differential coupler is switchable to a disengagement mode, comprising disengaging the movement of the first lower member and the movement of the second lower member.

18. The supporting exoskeleton according to claim 16, further comprising:
a vertical elastic element, and an intermittent support integrated with the vertical elastic element or separate therefrom, wherein the intermittent support comprises a plurality of exoskeleton vertebra elements positioned along at least a portion of the vertical elastic element adapted to be positioned along a back spine of a person when wearing the supporting exoskeleton,
at least one of the exoskeleton vertebra element being coupled to the vertical elastic element when the intermittent support is not integrated with the vertical elastic element, wherein adjacent exoskeleton vertebra elements are tiltably connected with each other, wherein the tilting is in a tilt plane, and
wherein each pair of adjacent exoskeleton vertebra elements is configured for stopping said tilting in the tilt plane at a predetermined maximum tilt angle,
wherein the intermittent support comprises means for changing said predetermined maximum tilt angle.

19. The supporting exoskeleton according to claim 18, wherein bending, in the tilt plane, of the vertical elastic element along the pair of adjacent exoskeleton vertebra elements is limited to a bend radius of at least 50 cm, or
wherein the predetermined maximum tilt angle, divided by a distance between the centers of the adjacent exoskeleton vertebra elements, is at most 2°/cm.

20. The supporting exoskeleton according to claim 18, wherein tilting is assumed to be stopped when a derivative of a torque exerted on the exoskeleton vertebra elements, in absence of the vertical elastic element, with respect to tilt angle, at a particular tilt angle, is five times larger than the torque, exerted on the exoskeleton vertebra elements, in absence of the vertical elastic element, divided by the particular tilt angle.

21. The supporting exoskeleton according to claim 18, wherein adjacent exoskeleton vertebra elements are connected to each other via a revolute joint.

22. The supporting exoskeleton according to claim 18, wherein the tiltable connection between adjacent exoskeleton vertebra elements comprises the vertical elastic element.

23. The supporting exoskeleton according to claim 18, wherein each exoskeleton vertebra element comprises a projecting element, wherein the projecting elements of adjacent exoskeleton vertebra elements are connected by a cable.

24. The supporting exoskeleton according to claim 18, wherein, in a situation wherein the intermittent support is linear, adjacent exoskeleton vertebra elements are separated from each other by a gap,
wherein the intermittent support is configured for reducing a magnitude of said gap when tilting, and configured for stopping said tilting when the gap is closed.

25. The supporting exoskeleton according to claim 16, wherein said tilt plane substantially coincides with a parasagittal plane of the person when the supporting exoskeleton is worn by said person, and
wherein the adjacent exoskeleton vertebra elements being configured for stopping said tilting comprises that the adjacent exoskeleton vertebra elements are configured for stopping said tilting in a forward direction with respect to said person.

26. The supporting exoskeleton according to claim 18,
wherein each of the exoskeleton vertebra elements is coupled to the vertical elastic element and/or
wherein the plurality of exoskeleton vertebra elements comprises at least three exoskeleton vertebra elements.

27. The supporting exoskeleton according to claim 18, wherein the supporting exoskeleton comprises a stiffness controller for controlling the stiffness.

28. A method for making the supporting exoskeleton according to claim 16,
comprising obtaining the different parts, and assembling said parts so as to form the supporting exoskeleton.

29. Use of the supporting exoskeleton according to claim 16 for lifting an object.
